(19) United States
(12) Patent Application Publication
(10) Pub. No.: US 2026/0118884 A1
(43) Pub. Date: Apr. 30, 2026

(54) AUTOMATIC POOL CLEANING APPARATUS, CONTROL METHOD, AND COMPUTER STORAGE MEDIUM

(71) Applicant: Shenzhen Aiper Intelligent Co., Ltd., Shenzhen (CN)

(72) Inventors: Zhenzhen LIANG, Suzhou, Jiangsu (CN); Cheng ZHANG, Suzhou, Jiangsu (CN); Gujie TANG, Suzhou, Jiangsu (CN); Kai ZHENG, Suzhou, Jiangsu (CN); Lingjie PENG, Suzhou, Jiangsu (CN); Qingxiang SONG, Suzhou, Jiangsu (CN); Liang BAO, Suzhou, Jiangsu (CN)

(73) Assignee: Shenzhen Aiper Intelligent Co., Ltd., Shenzhen (CN)

(21) Appl. No.: 19/429,482

(22) Filed: Dec. 22, 2025

(30) Foreign Application Priority Data
Dec. 22, 2024 (CN) 202411895606.6

(51) Int. Cl. G05D 1/648; E04H 4/16; G05D 1/246; G05D 1/622; G05D 105/10; G05D 107/00

(52) U.S. Cl. CPC G05D 1/648; E04H 4/1654; G05D 1/2469; G05D 1/622; G05D 2105/10; G05D 2107/29

(57) ABSTRACT

The present disclosure provides an automatic pool cleaning apparatus, a control method and a computer storage medium. The control method includes: obtaining predetermined information required for the automatic pool cleaning apparatus to perform repositioning; and determining whether the predetermined information satisfies a predetermined condition for the automatic pool cleaning apparatus to perform the repositioning, in a case where the predetermined condition is satisfied, controlling the automatic pool cleaning apparatus to perform the repositioning.

### CROSS-REFERENCE TO RELATED APPLICATION

This application claims priority to Chinese Patent Application No. 202411895606.6, filed on Dec. 22, 2024, which is hereby incorporated by reference in its entirety.

### FIELD

Embodiments of the present disclosure relate to the technical field of cleaning apparatus, and in particular, to an automatic pool cleaning apparatus, a control method and a computer storage medium.

### BACKGROUND

In the process of cleaning a pool, a pool cleaning robot mainly uses sensors to build drawings, perform positioning and avoid obstacles. However, there are relatively few types of sensors that can work underwater, and those existing sensors that can work stably (such as ultrasonic, imu, magnetometer, and wheel encoder, etc.) have limited ability and large errors to perceive the underwater environment. Moreover, with the progress of cleaning work, the pool cleaning robot will cause the situation of inaccurate positioning or even lost positioning due to moving error, smooth pool bottom, water wave resistance and other reasons. Therefore, how to enable the pool cleaning robot to start repositioning underwater and obtain accurate positioning information through repositioning is an urgent problem to be solved.

### SUMMARY

For defects of above-mentioned related art, the technical problem to be solved in the present disclosure is to provide a control method of an automatic pool cleaning apparatus. By obtaining predetermined information, and matching the predetermined information with a predetermined condition for the automatic pool cleaning apparatus to perform repositioning, that is, a periodic repositioning of the automatic pool cleaning apparatus is realized under the predetermined condition, so as to complete instructions more accurately.

According to another aspect of the present disclosure, an automatic pool cleaning apparatus applying the above-mentioned control method is provided.

According to another aspect of the present disclosure, a computer storage medium for implementing the above-mentioned control method is provided.

In an aspect of the present disclosure, a control method of an automatic pool cleaning apparatus is provided, including: obtaining predetermined information required for the automatic pool cleaning apparatus to perform repositioning; and determining whether the predetermined information satisfies a predetermined condition for the automatic pool cleaning apparatus to perform the repositioning, wherein in a case where the predetermined condition is satisfied, controlling the automatic pool cleaning apparatus to perform the repositioning.

Further, the predetermined information comprises a motion state, a work progress, a power situation, an instruction receiving situation or a situation of switching a cleaning mode; the predetermined condition comprises one or more of following conditions: the motion state satisfies the automatic pool cleaning apparatus having entered into a pool and having made its first contact with a bottom surface of the pool; the motion state satisfies the automatic pool cleaning apparatus having completed an escape action; the work progress satisfies the automatic pool cleaning apparatus having completed work and needing to return to an enter-into-water position; the power situation satisfies the automatic pool cleaning apparatus needing to return to a charging base station; the instruction receiving situation satisfies the automatic pool cleaning apparatus having received a predetermined instruction in the pool; and the situation of switching cleaning mode satisfies the automatic pool cleaning apparatus independently identifying a need of switching cleaning mode.

Further, the automatic pool cleaning apparatus comprises a first sensor, and the first sensor is used for obtaining information of the motion state.

Further, the first sensor is one of following sensors: a pressure sensor, an ultrasonic sensor, a photoelectric sensor, an infrared sensor, an accelerometer, and an inertial measurement unit.

Further, the predetermined instruction is one or more of following instructions: an instruction to stop cleaning work; an instruction to terminating the cleaning work; an instruction to recall the automatic pool cleaning apparatus; and an instruction to charge the automatic pool cleaning apparatus.

Further, the switching cleaning mode comprises a switching between any two modes below: a pool bottom mode, a pool wall mode, a waterline mode, a water surface mode, a step mode, a high coverage mode, a low coverage mode, a high efficiency mode, a fixed-point cleaning mode, a full coverage cleaning mode, and a supplementary cleaning mode.

Further, the controlling the automatic pool cleaning apparatus to perform repositioning comprises: obtaining map information of a pool edge or environmental information of the pool edge collected historically; controlling the automatic pool cleaning apparatus to move along the pool edge; collecting outline information of the pool edge or environmental information of the pool edge; matching the outline information of the pool edge or the environmental information of the pool edge with the map information of the pool edge or the environmental information of the pool edge collected historically, so as to obtain current position information of the automatic pool cleaning apparatus.

Further, the automatic pool cleaning apparatus further comprises a second sensor, and the second sensor is capable of detecting lateral obstacles of the automatic pool cleaning apparatus, so as to obtain the outline information of the pool edge or the environmental information of the pool edge.

Further, the map information of the pool edge or the environmental information of the pool edge collected historically is obtained by the second sensor.

The present disclosure also discloses an automatic pool cleaning apparatus including a controller, where the controller is configured to: obtain predetermined information required for the automatic pool cleaning apparatus to perform repositioning; and determine whether the predetermined information satisfies a predetermined condition for the automatic pool cleaning apparatus to perform the repositioning, wherein in a case where the predetermined condition is satisfied, the controller is configured to control the automatic pool cleaning apparatus to perform the repositioning.

Further, the predetermined information comprises a motion state, a work progress, a power situation, an instruction receiving situation or a situation of switching a cleaning mode.

The present disclosure also discloses a non-transitory computer storage medium having computer programs stored thereon, where the computer programs, when executed by a processor, implement a method described as any one of embodiments in the present disclosure.

The embodiments described in the present disclosure have the following beneficial effects: the automatic pool cleaning apparatus and the control method thereof provided in the present disclosure can start repositioning in a case where the predetermined condition is satisfied, and obtain accurate positioning information through repositioning. The determination and operation of this repositioning have the characteristics of periodicity and flexibility.

### BRIEF DESCRIPTION OF THE DRAWINGS

In order to more clearly illustrate technical solutions in embodiments of the present disclosure, a brief introduction will be made below to the accompanying drawings required for use in the description of the embodiments. The accompanying drawings described below are only exemplary embodiments of the present disclosure.

FIG. 1 is a flow diagram showing a control method of an automatic pool cleaning apparatus in an embodiment of the present disclosure.

### DETAILED DESCRIPTION OF EMBODIMENTS

The technical solutions in the present disclosure will be clearly and completely described below. Obviously, the described embodiments are only partial embodiments in the present disclosure and not all embodiments. Based on the embodiments in the present disclosure, all other embodiments obtained by persons having ordinary skill in the art (hereinafter “POSITA”) without creative labor all shall fall within the protection scope of the present disclosure. It should be illustrated that without contradicting each other, the embodiments in the present disclosure and the features in the embodiments may be combined with each other.

The present disclosure provides a control method of an automatic pool cleaning apparatus, and an automatic pool cleaning apparatus and a computer storage medium that apply the control method. The automatic pool cleaning apparatus of the present disclosure can clean the pool. The pool is, for example, a pool-shaped building. The pool-shaped building may be a swimming pool, a water storage pool, a hydrotherapy pool, a water storage tank, a water storage tank, and so on. The automatic pool cleaning apparatus may be an apparatus such as an automatic cleaning apparatus, a pool cleaning robot, and so on, which can clean the pool-shaped building. The present disclosure does not limit the specific presentation mode of the automatic pool cleaning apparatus and the pool-shaped building, as long as the principle of the present disclosure can be realized. Hereinafter, unless otherwise specified, the illustration is expanded with a robot as an example of the automatic pool cleaning apparatus, and with the swimming pool as an example of the pool or the pool-shaped building. Hereinafter, unless otherwise specified, the terms “a pool bottom”, “a bottom surface of a swimming pool”, and “a bottom of a swimming pool” refer to a bottom surface of a swimming pool.

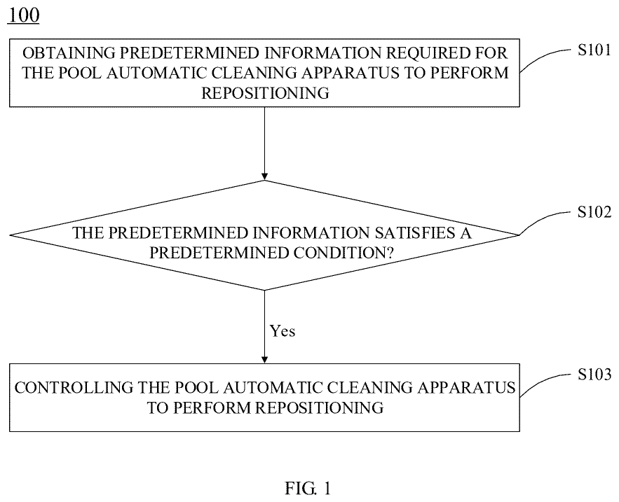

The control method 100 for the automatic pool cleaning apparatus of the present disclosure will be described below in combination with the accompanying drawings. FIG. 1 is a flow diagram showing a control method for an automatic pool cleaning apparatus according to an embodiment of the present disclosure. The control method 100 includes steps S101 to S103. Steps S101 to S103 are described below.

At step S101, obtaining predetermined information required for the automatic pool cleaning apparatus to perform repositioning.

Before cleaning the pool bottom, the robot will first build a map along the pool edge, that is, moving a circle or close to a circle along an outline of the swimming pool edge to build an outline map of the swimming pool (also known as a “local map”), and plan a cleaning route according to the result of building the map along the pool edge, and then clean along the planned cleaning route. By building the map along the pool edge and obtaining the outline map of the swimming pool, the robot can obtain its position on the pool bottom. In the process of cleaning, due to moving error, smooth pool bottom, water wave resistance and other reasons, the robot's positioning may be inaccurate or even lost. Therefore, the robot needs to perform positioning again (hereinafter referred to as “repositioning”) so that the robot can obtain current accurate positioning information and perform subsequent operations (such as returning to the enter-into-water point, re-cleaning missed area, etc.) based on the accurate positioning information.

The predetermined information includes motion state, work progress, power situation, instruction receiving situation or situation of switching cleaning mode.

In one embodiment, the predetermined information may include a variety of the following: motion state, work progress, power situation, instruction receiving situation or situation of switching cleaning mode.

The motion state may include: whether the automatic pool cleaning apparatus has entered into the water, the position of the robot in the pool, whether the automatic pool cleaning apparatus is in an inclined state, the speed state of the automatic pool cleaning apparatus (accelerating motion, decelerating motion or uniform motion), and other motion states.

The work progress may include: the cleaning mode the automatic pool cleaning apparatus is in, and the completion status of instructions within that mode.

The power situation may include: an actual power of the automatic pool cleaning apparatus, thereby determining whether the actual power satisfies requirements of completing the instruction.

The instruction receiving situation may include: the automatic pool cleaning apparatus receiving an instruction, identifying the received instruction to determine whether it is a predetermined instruction, or determining whether it is consistent with the instruction sent by a controller, and whether the instruction was received in a timely manner.

The situation of switching cleaning mode may include: whether the automatic pool cleaning apparatus automatically identifies a need of switching cleaning mode.

It should be noted that the above description of the predetermined information is only exemplary, and the predetermined information claimed by the present disclosure is not limited to the content listed above. A POSITA can set the type and content of the predetermined information according to the actual situation, as long as the technical principle of the present disclosure can be realized.

Next, proceed to step S102. At step S102, determining whether the predetermined information satisfies a predetermined condition for the automatic pool cleaning apparatus to perform repositioning.

The predetermined condition includes one or more of following conditions: the motion state satisfies the automatic pool cleaning apparatus having entered into a pool and having made its first contact with a bottom surface of the pool; the motion state satisfies that the automatic pool cleaning apparatus having completed its escape action; the work progress satisfies that the automatic pool cleaning apparatus having completed its work and needing to return to the enter-into-water position; the power situation satisfies that the automatic pool cleaning apparatus needing to return to a charging base station; the instruction receiving situation satisfies that the automatic pool cleaning apparatus having received a predetermined instruction in the pool; and the situation of switching cleaning mode satisfies that the automatic pool cleaning apparatus independently identifying a need of switching cleaning mode. The predetermined instruction is one or more of following instructions: an instruction to stop cleaning work; an instruction to terminate cleaning work; an instruction to recall the automatic pool cleaning apparatus; and an instruction to charge the automatic pool cleaning apparatus. The predetermined conditions and their determination will be described in detail in combination with specific embodiments below.

In a case where the predetermined condition is satisfied, proceed to step S103. At step S103, controlling the automatic pool cleaning apparatus to perform repositioning.

The following example describes a scenario where the predetermined information includes “motion state” and the predetermined condition includes “the motion state satisfies the automatic pool cleaning apparatus having entered into a pool and having made its first contact with a bottom surface of the pool”. For example, the automatic pool cleaning apparatus may include a first sensor, and the first sensor is used for obtaining the information of the motion state of the automatic pool cleaning apparatus. The first sensor may be one of the following sensors: a pressure sensor, an ultrasonic sensor, a photoelectric sensor, an infrared sensor, an accelerometer, and an inertial measurement unit. For example, a pressure sensor (e.g., enter-into-water sensor) may be used to determine that the robot has entered into the water; a pressure sensor (e.g., bottom contact sensor) may be used to determine that the robot has contacted the pool bottom; an accelerometer and/or inertial measurement unit may be used to determine whether the robot is stuck.

It can be understood that various types of sensors listed above are only the example of the first sensor used for obtaining the information of the motion state, and are not intended to limit the type of the first sensor, as long as the technical principles of the present disclosure can be realized.

The automatic pool cleaning apparatus may determine whether the predetermined condition is satisfied based on the information of the motion state obtained by the first sensor, that is, whether the motion state satisfies the automatic pool cleaning apparatus having enters into the pool and makes its first contact with the bottom surface of the pool. If it is determined that the automatic pool cleaning apparatus has not entered into the pool, then it means that the automatic pool cleaning apparatus is not working and does not need to perform repositioning. If it is determined that the automatic pool cleaning apparatus has entered into the pool and contacted with the bottom surface of the pool for the first time, then the position of the automatic pool cleaning apparatus on the bottom surface of the pool needs to be determined, that is, repositioning is needed.

The following example describes a scenario where the predetermined information includes “motion state” and the predetermined condition includes “the motion state satisfies the automatic pool cleaning apparatus having completed an escape action”. The automatic pool cleaning apparatus may determine whether the predetermined condition is satisfied based on the information of the motion state obtained by the first sensor, that is, whether the motion state satisfies that the automatic pool cleaning apparatus has completed its escape action. The robot determines its motion state through the information of the motion state obtained by the first sensor, so as to determine whether the robot is stuck and whether it has escaped. For example, the robot is entangled by foreign bodies such as hair and plastic rope in the swimming pool, or is stuck in narrow gaps such as drainage outlet and the bottom of steps, or is stuck by fallen objects such as toys and tools that are not cleaned up in the swimming pool. If the robot is stuck, it can be further determined whether its escape action has been completed according to the first sensor such as the IMU sensor. If its escape action has been completed, the position of the robot at the pool bottom needs to be determined, that is, repositioning is needed.

The following example describes a scenario where the predetermined information includes “work progress” and the predetermined condition includes “the work progress satisfies the automatic pool cleaning apparatus having completed work and needing to return to the enter-into-water position”. During the cleaning work of the automatic pool cleaning apparatus, due to the accumulation of small errors caused by turning and other operations, the actual position of the automatic pool cleaning apparatus will be different from its perceived position. If the robot performs returning to the enter-into-water position according to its perceived position, the actual returned position would not be the enter-into-water position, thereby making it impossible for workers to retrieve the automatic pool cleaning device from the enter-into-water position. The robot will determine whether the cleaning work has been completed according to the work progress. If the work has been completed, it needs to return to the enter-into-water position. Before returning to the enter-into-water position, the position of the robot at the pool bottom needs to be determined, that is, repositioning is needed.

The following example describes a scenario where the predetermined information includes “power situation” and the predetermined condition includes “the power situation satisfies the automatic pool cleaning apparatus needing to return to a charging base station”. During the cleaning work, the robot may measure the remaining power in real time to know whether its power can support the completion of all cleaning work. If the robot determines that the power cannot support the completion of all cleaning work, it needs to be recharged, that is, the robot needs to return to the charging base station for charging. Before returning to the charging base station, the position of the robot at the pool bottom needs to be determined, that is, repositioning is needed.

The following example describes a scenario where the predetermined information includes “instruction receiving situation” and the predetermined condition includes “the instruction receiving situation satisfies the automatic pool cleaning apparatus having received a predetermined instruction in the pool”. The predetermined instruction is one or more of following instructions: an instruction to stop cleaning work; an instruction to terminate cleaning work; an instruction to recall the automatic pool cleaning apparatus; and an instruction to charge the automatic pool cleaning apparatus. If the robot receives an instruction, the instruction can be recognized to determine whether the instruction belongs to one or more of the above-mentioned predetermined instructions. If the received instruction is one or more of the predetermined instructions, the predetermined condition is satisfied. For example, if the instruction received by the robot is an instruction to terminate the cleaning work, then the predetermined condition is satisfied, and the robot needs to perform repositioning so that after the cleaning work is terminated, the robot can obtain its current accurate positioning information and move to a predetermined position accordingly; if the instruction received by the robot is an instruction to recall the robot, then the predetermined condition is satisfied, and the robot needs to perform repositioning, that is, the robot needs to be repositioned before being recalled in order to obtain its current accurate positioning information, thereby avoiding path deviation while the robot is recalled.

The following example describes a scenario where the predetermined information includes “situation of switching cleaning mode” and the predetermined condition includes “the situation of switching cleaning mode satisfies the automatic pool cleaning apparatus independently identifying a need of switching cleaning mode”. The situation of switching the cleaning mode includes the switching between any two modes below: a pool bottom mode, a pool wall mode, a waterline mode, a water surface mode, a step mode, a high coverage mode (dense route, high coverage), a low coverage mode, a high efficiency mode (high execution efficiency for planned path, but low coverage), a fixed-point cleaning mode (cleaning only where dirt is detected, leaving undetected areas uncleaned), a full coverage cleaning mode, and a supplementary cleaning mode (after cleaning in the previous mode, determining where areas are missed based on vision or the walking path+map, and then supplementing cleaning in those missed areas).

The pool bottom mode is the conventional cleaning mode of the automatic pool cleaning apparatus, that is, the pool bottom is cleaned.

The pool wall mode is also known as a wall-climbing mode, which mainly uses the vacuum adsorption principle to attach the automatic pool cleaning apparatus to a pool wall to clean it.

The waterline mode primarily conducts circumferential cleaning along the waterline at the edge of the swimming pool. The automatic pool cleaning apparatus can stably float near the waterline by controlling its own buoyancy, and taking the wall as a reference, it maintains a fixed distance from the wall by the sensor, ensuring that the cleaning components of the automatic pool cleaning apparatus can contact the waterline and perform cleaning.

The water surface mode is also known as a water surface boat mode. In this mode, the buoyancy of the automatic pool cleaning apparatus is adjusted to control the vertical floating of the automatic pool cleaning apparatus on the water surface, so as to clean the water surface.

The step mode is for the automatic pool cleaning apparatus to clean steps. The automatic pool cleaning apparatus uses sensor to detect and position a step, and constructs a map of the step through data collection, and the map includes the height, width, and depth of the step, and the spacing between steps, etc. Then the automatic pool cleaning apparatus plans a route, and cleans the edge of the step, the tread of the step and the vertical surface of the step, respectively. The specific cleaning order will be set according to the actual needs, and the present disclosure will not be limited.

The high coverage mode mainly adopts intensive route planning to ensure that every small area can be covered. For example, the automatic pool cleaning apparatus can use a small spacing bow-shaped or grid-shaped route at the pool bottom, so that the cleaning route will be crisscrossed, thereby achieving a high coverage.

The low coverage mode mainly uses wide-spacing straight lines or simple broken-line routes. Specifically, the automatic pool cleaning apparatus is cleaned along the main axis of the center of the pool bottom, or the parallel line routes with a large interval are used to clean the main part of the pool bottom, and the edge area is simply cleaned.

The high efficiency mode mainly adopts the shortest route to plan for the area to be cleaned, specifically to complete the cleaning with the shortest cleaning route. For example, when the pool bottom is rectangular, it can adopt a straight route along the long side of the rectangle to reduce the number of turns, or a straight line along the diagonal through the pool bottom. The above-mentioned rectangular pool bottom is only an embodiment of the present disclosure, and the high efficiency cleaning mode for circular pool bottom or irregular shape pool bottom, etc., is the protection content of the present disclosure.

The fixed-point cleaning mode is mainly used by the automatic pool cleaning apparatus to determine the location of dirt or a lot of dirt through visual sensors or previous cleaning records. It moves directly to the identified location and plans a small cleaning path around the dirt. This path may be a circular or square area, or other areas, and then it performs targeted cleaning.

The full-coverage cleaning mode is mainly to completely clean the cleaning area. For the cleaning of the pool bottom, multiple route planning can be carried out according to the shape of the pool bottom, such as cleaning the pool edge first, and then cleaning the center of the pool bottom. For the cleaning of the pool wall, the cleaning can be carried out along the upper and lower edges of the pool wall and the entire height of the wall. For corners and pool edges, the cleaning can be carried out along an inclined path, a spiral path or a circumferential path. In the full-coverage cleaning mode, the route planning is based on actual pools and is not limited in this application.

The supplementary cleaning mode is mainly based on the route record of the previous cleaning mode and the map information, or uses the visual sensor to scan the swimming pool to identify the uncleaned areas. A cleaning path is then planned for these uncleaned areas. The planned route must cover these areas and can be a straight line, a circle, or an irregular path within a small scope, or any other route designed to cover the uncleaned areas. Cleaning is then completed based on the planned route.

For example, after the automatic pool cleaning apparatus completes the cleaning work of the planned cleaning route, if it detects an uncleaned area or an area with poor cleaning effect, the robot can switch to the fixed-point cleaning mode or the supplementary cleaning mode. If the automatic pool cleaning apparatus detects that the overall condition of the pool is relatively clean after entering into the water, it can switch from the high-coverage mode to the high-efficiency mode. After cleaning the pool bottom (using the pool bottom mode), the automatic pool cleaning apparatus can switch to the pool wall mode or the water surface mode. The automatic pool cleaning apparatus adopts the high-coverage mode to carefully clean the pool bottom, but when the pool bottom is found to be relatively clean during the cleaning process, it can be switched to a fixed-point cleaning mode. The automatic pool cleaning apparatus can also switch cleaning mode independently according to the actual situation. The automatic pool cleaning apparatus identifies automatically that the cleaning mode needs to be switched, which satisfies the predetermined condition for repositioning, that is, the robot needs to be repositioned after or before switching cleaning mode.

It should be noted that each predetermined condition described above can be the determination of a single condition, or the determination of multiple conditions, in other words, if any one of the above predetermined conditions is satisfied, the automatic pool cleaning apparatus can be controlled to perform repositioning, or if multiple predetermined conditions are satisfied, the automatic pool cleaning apparatus can be controlled to perform repositioning. A POSITA can determine the above types of predetermined information according to actual needs, as long as the functions of the present disclosure can be realized.

The repositioning is described below. The repositioning of the automatic pool cleaning apparatus includes obtaining map information of a pool edge or environmental information of the pool edge collected historically, controlling the automatic pool cleaning apparatus to move along the pool edge, collecting outline information of the pool edge or environmental information of the pool edge, matching the collected outline information of the pool edge or the collected environmental information of the pool edge with the map information of the pool edge or the environmental information of the pool edge collected historically, so as to obtain current position information of the automatic pool cleaning apparatus.

The map information of the pool edge or the environmental information of the pool edge collected historically may be the outline map described above, and the outline map may be the map constructed by the robot after it enters into the water and moves a circle or close to a circle along an outline of a swimming pool edge; the map information of the pool edge or the environmental information of the pool edge collected historically may be the map information or environmental information of the pool read by the robot from a historical database; or the map information of the pool edge or the environmental information of the pool edge collected historically may be the map information or environmental information preset by user.

In one embodiment, the automatic pool cleaning apparatus also includes a second sensor. The second sensor may be a variety of sensors. For example, the second sensor may be a single point ultrasonic sensor. The single point ultrasonic sensor is mainly used to measure distance and detect obstacles. A single point ultrasonic sensor can convert ultrasonic signals into other energy signals (such as electrical signals). Ultrasonic wave is a mechanical wave with a vibration frequency higher than 20 kHz. It has the characteristics of high frequency, short wavelength, small diffraction phenomenon, especially good directivity, and can become a ray and directional propagation. The single point ultrasonic sensor can be composed of one or more fixed ultrasonic array elements, and the distance is calculated by measuring the time of ultrasonic wave from transmission to reception, so as to detect whether there are obstacles and the position of the obstacles. The single point ultrasonic sensor may also include a drive circuit, a signal processor and other components, the detailed description of these components is omitted here. In addition, the second sensor may include one or more of a camera, a single photon imaging sensor (DTOF), an infrared sensor, or a radar.

The repositioning of the automatic pool cleaning apparatus can be performed as follows: obtaining map information of a pool edge by the second sensor or obtaining environmental information of the pool edge collected historically; controlling the automatic pool cleaning apparatus to move along the pool edge; collecting outline information of the pool edge or environmental information of the pool edge; matching the collected outline information of the pool edge or the collected environmental information of the pool edge with the map information of the pool edge or the environmental information of the pool edge collected historically, so as to obtain current position information of the automatic pool cleaning apparatus.

The automatic pool cleaning apparatus also includes a second sensor, the second sensor may be one of the following sensors: a distance sensor, a pressure sensor, an ultrasonic sensor, a photoelectric sensor, an infrared sensor, an accelerometer, and an inertial measurement unit. The second sensor is capable of detecting lateral obstacles of the automatic pool cleaning apparatus to obtain the outline information of the pool edge or the environmental information of the pool edge. The map information of the pool edge or the environmental information of the pool edge collected historically is obtained by the second sensor.

For example, the robot obtains the outline map of the swimming pool through the second sensor in the process of building map along the pool edge after entering the water. During the repositioning, the robot collects the outline information of the pool edge or the environmental information of the pool edge through the second sensor, and matches the outline information or the environmental information obtained during the repositioning with the outline information or environmental information obtained in the process of building map along the pool edge, that is, the matching relationship between the moving route during the repositioning and the outline map of the swimming pool may be obtained. In other words, a route on the outline map of the swimming pool corresponding to the moving route during the repositioning may be obtained, and based on the corresponding route on the outline map, a coordinate transformation relationship between the current position of the robot and the origin of the outline map of the swimming pool may be calculated, and thus the current positioning information of the robot may be obtained.

The control method of the automatic pool cleaning apparatus provided in the present disclosure can start repositioning in a case where the predetermined condition is satisfied, and obtain accurate positioning information through the repositioning. The determination and operation of the repositioning have the characteristics of periodicity and flexibility.

The present disclosure also provides an automatic pool cleaning apparatus. The automatic pool cleaning apparatus includes a controller, and the controller is configured to: obtain predetermined information required for the automatic pool cleaning apparatus to perform repositioning; and; and determine whether the predetermined information satisfies a predetermined condition for the automatic pool cleaning apparatus to perform the repositioning, and in a case where the predetermined condition is satisfied, the controller is configured to control the automatic pool cleaning apparatus to perform the repositioning.

The technical contents such as the predetermined information, the predetermined condition, and the repositioning have been described in detail in the above-mentioned embodiments and will not be repeated here.

The present embodiment discloses a computer storage medium having computer programs stored thereon, and the computer programs, when executed by a processor, implement the above-mentioned control method.

It should be understood that in the present embodiment, the above-mentioned computer storage medium may be located on at least one network server in the multiple network servers of the computer network. Optionally, in the present embodiment, the above-mentioned computer storage medium may include, but is not limited to, various medium capable of storing program code, such as USB flash drive, Read Only Memory (ROM), Random Access Memory (RAM), portable hard disk, magnetic disk, or optical disc.

It should be noted that the above order of embodiments in the present disclosure is only for description and does not represent the merits of embodiments.

In the description of this specification, references to terms such as “one embodiment,” “some embodiments,” “example,” “specific example,” or “some examples,” etc., indicate that a specific feature, structure, material, or characteristic described in connection with that embodiment or example is included in at least one embodiment or example of this application. Furthermore, the specific features, structures, materials, or characteristics described may be combined in any suitable manner in one or more embodiments or examples. Moreover, without contradiction, a POSITA can combine and integrate the different embodiments or examples described in this specification, as well as the features of those different embodiments or examples.

In addition, the terms “first” and “second” are used for descriptive purposes only and are not to be understood as indicating or implying relative importance or as implicitly indicating the quantity of technical features indicated. In view of this, a feature defined as “first” or “second” may explicitly or implicitly include at least one of the features. In the description of the present disclosure, “multiple” means two or more, unless otherwise expressly and specifically defined.

In the present disclosure, where the contrary is not stated, the used positional words such as “up and down” are usually used for the directions shown in the accompanying drawings, or the vertical, perpendicular or gravitational directions; similarly, for ease of understanding and description, “left and right” usually refers to the left and right shown in the accompanying drawings; “inside and outside” refers to the inside and outside relative to the outline of each part itself, but the above positional words are not used to limit the present disclosure.

The contents described above are only exemplary implementations of the present disclosure, and cannot be used to limit the protection scope of the present disclosure. In technical scope recorded in the present disclosure, a POSITA can easily think of various changes or replacements thereof, which all shall be covered within the protection scope of the present disclosure. Therefore, the protection scope of the present disclosure shall be governed by the protection scope of claims.

I/We claim:

1. A control method of an automatic pool cleaning apparatus, comprising:
obtaining predetermined information required for the automatic pool cleaning apparatus to perform repositioning; and
determining whether the predetermined information satisfies a predetermined condition for the automatic pool cleaning apparatus to perform the repositioning,
wherein in a case where the predetermined condition is satisfied, controlling the automatic pool cleaning apparatus to perform the repositioning.

2. The control method according to claim 1, wherein
the predetermined information comprises a motion state, a work progress, a power situation, an instruction receiving situation or a situation of switching cleaning mode;
the predetermined condition comprises one or more of following conditions:
the motion state satisfies the automatic pool cleaning apparatus having entered into a pool and having made its first contact with a bottom surface of the pool;
the motion state satisfies the automatic pool cleaning apparatus having completed an escape action;
the work progress satisfies the automatic pool cleaning apparatus having completed work and needing to return to an enter-into-water position;
the power situation satisfies the automatic pool cleaning apparatus needing to return to a charging base station;
the instruction receiving situation satisfies the automatic pool cleaning apparatus having received a predetermined instruction in the pool; and
the situation of switching cleaning mode satisfies the automatic pool cleaning apparatus independently identifying a need of switching cleaning mode.

3. The control method according to claim 2, wherein the automatic pool cleaning apparatus comprises a first sensor, and the first sensor is used for obtaining information of the motion state.

4. The control method according to claim 3, wherein the first sensor is one of following sensors: a pressure sensor, an ultrasonic sensor, a photoelectric sensor, an infrared sensor, an accelerometer, and an inertial measurement unit.

5. The control method according to claim 2, wherein the predetermined instruction is one or more of following instructions:
an instruction to stop cleaning work;
an instruction to terminate cleaning work;
an instruction to recall the automatic pool cleaning apparatus; and
an instruction to charge the automatic pool cleaning apparatus.

6. The control method according to claim 2, the switching cleaning mode comprises a switching between any two modes below: a pool bottom mode, a pool wall mode, a waterline mode, a water surface mode, a step mode, a high coverage mode, a low coverage mode, a high efficiency mode, a fixed-point cleaning mode, a full coverage cleaning mode, and a supplementary cleaning mode.

7. The control method according to claim 1, wherein the controlling the automatic pool cleaning apparatus to perform repositioning comprises: obtaining map information of a pool edge or environmental information of the pool edge collected historically; controlling the automatic pool cleaning apparatus to move along the pool edge; collecting outline information of the pool edge or environmental information of the pool edge; matching the outline information of the pool edge or the environmental information of the pool edge with the map information of the pool edge or the environmental information of the pool edge collected historically, so as to obtain current position information of the automatic pool cleaning apparatus.

8. The control method according to claim 7, the automatic pool cleaning apparatus further comprises a second sensor, and the second sensor is capable of detecting lateral obstacles of the automatic pool cleaning apparatus, so as to obtain the outline information of the pool edge or the environmental information of the pool edge.

9. The control method according to claim 8, wherein the map information of the pool edge or the environmental information of the pool edge collected historically is obtained by the second sensor.

10. An automatic pool cleaning apparatus comprising a controller, wherein the controller is configured to:
obtain predetermined information required for the automatic pool cleaning apparatus to perform repositioning; and
determine whether the predetermined information satisfies a predetermined condition for the automatic pool cleaning apparatus to perform the repositioning,
wherein in a case where the predetermined condition is satisfied, the controller is configured to control the automatic pool cleaning apparatus to perform the repositioning.

11. The automatic pool cleaning apparatus according to claim 10, wherein the predetermined information comprises a motion state, a work progress, a power situation, an instruction receiving situation or a situation of switching cleaning mode.

12. A non-transitory computer storage medium having computer programs stored thereon, wherein the computer programs, when executed by a processor, implement the control method according to claim 1.
